(19) United States
(12) Patent Application Publication
(10) Pub. No.: US 2003/0190216 A1
(43) Pub. Date: Oct. 9, 2003

(54) Turn-lock assembly screw

(75) Inventor: Thomas J. Livingston, Homer, NY (US)

Correspondence Address: WALL MARJAMA & BILINSKI, 101 SOUTH SALINA STREET, SUITE 400, SYRACUSE, NY, 13202, US

(73) Assignee: Pass & Seymour, Inc.

(21) Appl. No.: 10/118,304

(22) Filed: Apr. 8, 2002

(51) Int. Cl. F16B 23/00

(52) U.S. Cl. 411/403

(57) ABSTRACT

An assembly screw having a deep driver tri-drive head configuration which in use transmits a high improved torque application. The head configuration has a slot configuration, Phillips recess and Robertson square drive recess which are significantly deeper than industry standards.

### FIELD OF THE INVENTION

This invention relates generally to assembly screws, and more specifically to an assembly screw having an head/driver recess configuration which provides for a deep screw drive recess.

### BACKGROUND OF THE INVENTION

During assembly operations using screws, the assembler is required to apply some measure of force along the axis of the screw to the driver to ensure that the driver remains engaged in the screw drive slot. The force required is exacerbated by the existence of type “U” threads utilized on assembly screws to create a fast seating assembly process. Any minor mis-alignment of the driver to the screw drive recess increases the potential of a driver slipping out of the driver slots. Conventional assembly screws typically have a ratio of drive depth to screw diameter of about 0.44. This typical drive depth results in problems with the driver unseating in situations requiring high torque applications. There is therefore a need in certain assembly operations for an assembly screw design which insures proper driver seating in high torque applications.

### SUMMARY OF THE INVENTION

It is therefore an object of the present invention to overcome the problems of the prior art described above.

It is another object of the present invention to provide an assembly screw having a drive recess configuration which transmits a higher torque than standard recess configurations.

It is yet another object of the present invention to provide an assembly screw having an improved head/driver recess configuration.

It is a further object of the present invention to provide an assembly screw having a deep drive recess which insures proper driver seating at greater angles of misalignment then prior art screws.

The present invention is directed to an assembly screw having a drive recess configuration which transmits a much higher torque application than the standard slot configuration of prior art screws. This recess configuration provides a very secure feel to the installer when assembling the product. A deeper screw drive recess design provides greatly increased driver security in the screw drive recess. The driver will remain properly seated at a much greater angle of mis-alignment of screw to driver axis. For the design of the present invention, the ratio of the drive depth to screw diameter is approximately 0.63. The new head/driver recess configuration also creates the impression of a much more secure driver-to-screw interface. The design additionally provides for a visually much improved assembly when compared to a standard prior art screw with the screw head/driver recess configuration creating an impression of a very high quality finished product.

In a preferred embodiment of the invention, the assembly screw has a tri-drive head configuration which incorporates a straight drive, Phillips drive recess, and a Robertson square drive recess which allows for the application of any normal driver to install or remove the assembly screw.

### BRIEF DESCRIPTION OF THE DRAWINGS

For a further understanding of these and objects of the invention, reference will be made to the following detailed description of the invention which is to be read in connection with the accompanying drawings, wherein:

FIG. 1 is a perspective view of the assembly screw of the present invention.

FIG. 2 is an end view of the assembly screw of the present invention.

FIG. 3 is a side view of the assembly screw of the present invention.

FIG. 4 is an end view of a turnlock connector utilizing the assembly screws of the present invention.

FIG. 5 is an end view of a turnlock plug utilizing the assembly screws of the present invention.

### DETAILED DESCRIPTION OF THE INVENTION

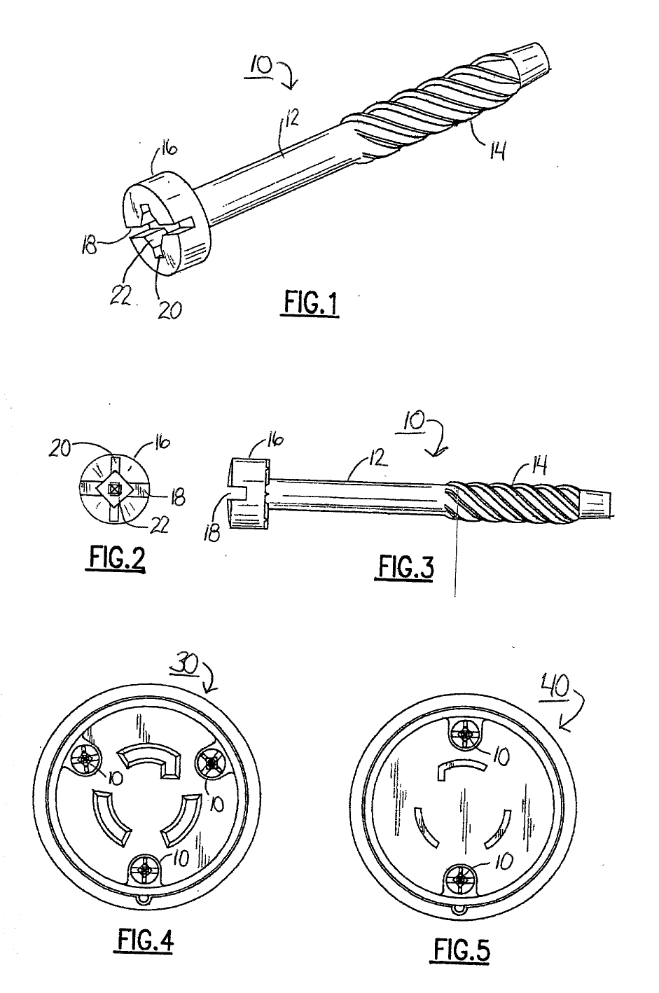

The invention is illustrated more specifically with reference to the drawings wherein FIG. 1 illustrates a perceptive view of the deep driver configuration of the present invention. In FIG. 1 assembly screw 10 comprises an elongated shaft 12 a plurality of U shaped threads 14 at one end, and a head 16 at the opposite end. The head contains a deep slot 18 which accommodates a straight drive and a deep recess 20 which accommodates a Phillips drive. The head further contains a deep square drive recess 22 which accommodates a Robertson square drive. FIG. 3 illustrates a side view of the assembly screw and FIG. 2 illustrates an end view of the head section. In FIGS. 4 and 5, respectively plug and connector assembly 30 and 40 illustrates a typical use of the screw of the present invention.

The design of the new deeper driver configuration in the head of the assembly screw of the present invention functions to prevent an installer from being injured by the drive tool if the driver should slip out of the drive recess in the screw head. During assembly using screws, the assembler is required to apply some measure of force along the axis of the screw to the driver to ensure the driver remains engaged in the screw drive recess. If the driver is slightly out of alignment with the screw drive recess this greatly increases the potential of a driver slipping out of the driver recess.

The deeper screw drive recess design provides greatly increased driver security in the screw drive recess. The driver will remain properly seated at a much greater angle of misalignment of screw to driver axis. The deeper drive recess mandates a taller head configuration to provide the necessary material/part strength around the deeper recess.

For comparison, the ANSI standard #6 screw drive specification for a Phillips Cross recess, type 1, recess penetration depth is 0.055/0.080. The ANSI specified Fillister total head height is specified to be 0.111/0.132. The ANSI specified #6 Fillister head diameter is 0.208/0.226. The ratio of drive depth to screw diameter is 0.440.

The #6 screw drive specification of the Phillips Cross recess, type 1, driver size 2 in one embodiment of the present invention has a recess penetration depth of 0.115/0.142. The head height is 0.145/0.160. The head diameter is 0.256/0.270 and the ratio of drive depth to screw diameter is 0.630.

The present invention is directed for use with both a #6 and #4 fillister head screws having the following design features and dimensions as tabulated below:

COMPARISON OF PRESENT INVENTION DESIGN TO
ANSI/ASME STANDARDS #6 FILLISTER
HEAD SCREW

| | ANSI/ASME | NEW DESIGN | % CHANGE |
|---|---|---|---|
| Head Height: | .111/.132 | .145/.160 | +25% |
| Head Diameter: | .208/.226 | .256/.270 | +21% |
| Slot Depth: | .045/.060 | .065/.086 | +44% |
| Phillips Recess | .055/.080 | .115/.145 | +90% |
| Penetration Gaging Depth: | | | |
| Square Drive | .057/.065 | .090/.110 | +64% |
| Penetration Gaging Depth: | | | |
| (IFI standards) | | | |

FORMULAS FOR HEAD DIMENSIONS

| | ANSI/ASME | NEW DESIGN |
|---|---|---|
| Max Head Diameter: | 1.670 D − .004 | 1.985 D − .004 |
| Max Total Head Height: | .940 D + .002 | 1.145 D + .002 |
| Max Slot Depth: | .440 D − .001 | .630 D − .001 |

Where D = basic Screw Diameter (.138 for #6 thread)

All ANSI/ASME dimensions and formulas from FASTENER STANDARDS, SIXTH EDITION by Industrial Fasteners Institute.

COMPARISON OF PRESENT INVENTION DESIGN TO
ANSI/ASME STANDARDS #4 FILLISTER
HEAD SCREW

| | ANSI/ASME | NEW DESIGN | % CHANGE |
|---|---|---|---|
| Head Height: | .088/.107 | .104/.130 | +25% |
| Head Diameter: | .166/.183 | .204/.218 | +21% |
| Slot Depth: | .035/.048 | .055/.070 | +44% |
| Phillips Recess | .056/.072 | .090/.106 | +53% |
| Penetration Gaging Depth: | | | |
| Square Drive | .032/.038 | .055/.061 | +64% |
| Penetration Gaging Depth: | | | |
| (IFI standards) | | | |

FORMULAS FOR HEAD DIMENSIONS

| | ANSI/ASME | NEW DESIGN |
|---|---|---|
| Max Head Diameter: | 1.670 D − .004 | 1.985 D − .004 |
| Max Total Head Height: | .940 D + .002 | 1.145 D + .002 |
| Max Slot Depth: | .440 D − .001 | .630 D − .001 |

Where D = basic Screw Diameter (.112 for #4 thread)

All ANSI/ASME dimensions and formulas from FASTENER STANDARDS, SIXTH EDITION by Industrial Fasteners Institute.

The #4 and #6 assembly screws may embody the tri-drive recess configuration, any single drive recess, or any combination of 2 drive recesses described herein.

The new drive recess configuration of the present invention transmits a much higher torque application than the standard recess configuration of prior art screws. This recess configuration provides a very secure feel to the installer when assembling the product. The new head/recess configuration also creates the impression of a much more secure driver-to-screw interface. In addition, the result is a visually much improved assembly when compared to a standard prior art screw.

The new screw head/recess configuration of the new assembly screws creates an impression of a very high quality finished product.

While the present invention has been particularly shown and described with reference to the preferred mode as illustrated in the drawings, it will be understood by one skilled in the art that various changes in detail may be effected therein without departing from the spirit and scope of the invention as defined by the claims.

We claim:

1. A #4 assembly screw which comprises an elongated shaft having a plurality of type “U” threads at one end and a head at said opposite end, with said head having tri-drive configuration of the following specifications:

| | |
|---|---|
| Head Height: | .104/.130 |
| Head Diameter: | .204/.218 |
| Slot Depth: | .055/.070 |
| Phillips Recess Penetration Gaging Depth: | .090/.106 |
| Square Drive Penetration Gaging Depth: | .055/.061 |
| (IFI standards). | |

2. A #4 assembly screw which comprises an elongated shaft having a plurality of type “U” threads at one end and a head at said opposite end, with said head having a combination head configuration of the following specifications:

| | |
|---|---|
| Head Height: | .104/.130 |
| Head Diameter: | .204/.218 |
| Slot Depth: | .055/.070 |
| Phillips Recess Penetration Gaging Depth: | .090/.106. |

3. A #4 assembly screw which comprises an elongated shaft having a plurality of type “U” threads at one end and a head at said opposite end, with said head having a combination head configuration of the following specifications:

| | |
|---|---|
| Head Height: | .104/.130 |
| Head Diameter: | .204/.218 |
| Slot Depth: | .055/.070 |
| Square Drive Penetration Gaging Depth: | .055/.061 |
| (IFI standards). | |

4. A #4 assembly screw which comprises an elongated shaft having a plurality of type “U” threads at one end and a heat at said opposite end, with said head having a combination head configuration of the following specifications:

| | |
|---|---|
| Head Height: | .104/.130 |
| Head Diameter: | .204/.218 |
| Phillips Recess Penetration Gaging Depth: | .090/.106 |
| Square Drive Penetration Gaging Depth: | .055/.061 |
| (IFI standards). | |

5. A #4 assembly screw which comprises an elongated shaft having a plurality of type “U” threads at one end and a head at opposite end, with said head having a slot configuration of the following specifications:

| | |
|---|---|
| Head Height: | .104/.130 |
| Head Diameter: | .204/.218 |
| Slot Depth: | .055/.070. |

6. A #4 assembly screw which comprises an elongated shaft having a plurality of type “U” threads at one end and a heat at said opposite end, with said head having a Phillips configuration of the following specifications:

| | |
|---|---|
| Head Height: | .104/.130 |
| Head Diameter: | .204/.218 |
| Phillips Recess Penetration Gaging Depth: | .090/.106. |

7. A #4 assembly screw which comprises an elongated shaft having a plurality of type “U” threads at one end and a head at said opposite end, with said head having a square device configuration of the following specifications:

| | |
|---|---|
| Head Height: | .104/.130 |
| Head Diameter: | .204/.218 |
| Square Drive Penetration Gaging Depth: | .055/.061 |
| (IFI standards). | |

8. A #6 assembly screw which comprises an elongated shaft having a plurality of type “U” threads at one end and a head at said opposite end, with said head having a tri-drive configuration of the following specifications:

| | |
|---|---|
| Head Height: | .145/.160 |
| Head Diameter: | .256/.270 |
| Slot Depth: | .065/.086 |
| Phillips Recess Penetration Gaging Depth: | .115/.145 |
| Square Drive Penetration Gaging Depth: | .090/.110 |
| (IFI standards). | |

9. A #6 assembly screw which comprises an elongated shaft having a plurality of type “U” threads at one end and a head at said opposite end, with said head having a combination head configuration of the following specifications:

| | |
|---|---|
| Head Height: | .145/.160 |
| Head Diameter: | .256/.270 |
| Slot Depth: | .065/.086 |
| Phillips Recess Penetration Gaging Depth: | .115/.145. |

10. A #6 assembly screw which comprises an elongated shaft having a plurality of type “U” threads at one end and a head at said opposite end, with said head having a combination tri-drive head configuration of the following specifications:

| | |
|---|---|
| Head Height: | .145/.160 |
| Head Diameter: | .256/.270 |
| Slot Depth: | .065/.086 |
| Square Drive Penetration Gaging Depth: | .090/.100 |
| (IFI standards). | |

11. A #6 assembly screw which comprises an elongated shaft having a plurality of type “U” threads at one end and a head at said opposite end, with said head having a combination head configuration of the following specifications:

| | |
|---|---|
| Head Height: | .145/.160 |
| Head Diameter: | .256/.270 |
| Phillips Recess Penetration Gaging Depth: | .115/.145 |
| Square Drive Penetration Gaging Depth: | .090/.110 |
| (IFI standards). | |

12. A #6 assembly screw which comprises an elongated shaft having a plurality of type “U” threads at one end and a head at said opposite end, with said head having a slot configuration of the following specifications:

| | |
|---|---|
| Head Height: | .145/.160 |
| Head Diameter: | .256/.270 |
| Slot Depth: | .65/.086. |

13. A #6 assembly screw which comprises an elongated shaft having a plurality of type “U” threads at one end and a head at said opposite end, with said head having a Phillips configuration of the following specifications:

| | |
|---|---|
| Head Height: | .145/.160 |
| Head Diameter: | .256/.270 |
| Phillips Recess Penetration Gaging Depth: | .115/.145. |

14. A #6 assembly screw which comprises an elongated shaft having a plurality of type “U” threads at one end and a head at said opposite end, with said head having a square drive configuration of the following specifications:

| | |
|---|---|
| Head Height: | .145/.160 |
| Head Diameter: | .256/.270 |
| Square Drive Penetration Gaging Depth: | .090/.110 |
| (IFI standards). | |
